(19) United States
(12) Patent Application Publication
(10) Pub. No.: US 2026/0024117 A1
(43) Pub. Date: Jan. 22, 2026

(54) SYSTEMS AND METHODS FOR ASSET VALUATION

(71) Applicants: Christian Saucier, West Union, SC (US); Allison Vagner, Encinitas, CA (US); Dale Hunt, Escondido, CA (US)

(72) Inventors: Christian Saucier, West Union, SC (US); Allison Vagner, Encinitas, CA (US); Dale Hunt, Escondido, CA (US)

(21) Appl. No.: 19/273,966

(22) Filed: Jul. 18, 2025

Related U.S. Application Data
(60) Provisional application No. 63/673,008, filed on Jul. 18, 2024.

(51) Int. Cl. G06Q 30/02; G06Q 30/0207

(52) U.S. Cl. CPC G06Q 30/0278; G06Q 30/0207

(57) ABSTRACT

The invention provided herein generally relates to devices, systems, and methods for valuing assets, including physical and digital, cash and non-cash assets, by transmitting information to an appraiser network including users who submit appraisal bids, wherein the appraiser network users have reputation scores, and wherein the users are incentivized for participation and rewarded based on the asset value and/or sale price, optionally using machine learning and/or artificial intelligence to provide a reward and/or reward estimate. In some embodiments, the asset is digitized, and the invention allows for transactions involving the digitized asset and/or the value of the digitized asset.

### BACKGROUND

Estimating the value of an asset is a difficult task. Different people value things differently. Yet, when people do exchange things with one another, they find a value agreement they call the “price.” In a voluntary exchange, both the seller and the buyer believe they are better off after the exchange, otherwise they would have walked away from the trade. By completing the trade, the parties turn an “estimated price” into a “fair price.” This process, however, is often costly, time consuming, and prone to numerous risks like fraud and other external pressures.

As a result, market forces led to reputable brands, marketplaces and shopping centers, where many buyers can congregate around many sellers in the hopes of reaching a trade at a fair price on quality items. Standardization and commoditization also have an important role to play in asset valuation. Commodity assets are conveniently priced in global exchanges where buyers and sellers negotiate the “market price” at which food stocks, metals, energy, and other things society needs find their fair valuation. This facilitates exchanges across the whole of society.

However, what works well for fungible assets works less efficiently for unique assets. It may be very difficult to determine the value of a specific painting found in an attic, an antique chest, a collectible non-fungible token, secondary-market event tickets, or the value of a patent. These assets do not benefit from having readily available marketplaces to determine their fair value. Instead, one must find a specialist or a local expert to offer a more authoritative estimate. Such experts can be found at auction houses, car dealerships, pawn shops, jewelry stores, or the like. In most cases, the expert estimate suffers from multiple weaknesses:
a. The estimate from a single “expert”
b. Experts often disagree with one another
c. Cost of finding an expert can discourage sellers
d. Locality restrains the valuation; global reach increases the reliability of the valuation
e. Assessment independence is rare (the expert is often a party to the trade)

In times of economic hardship, more people will turn to barter and trade, which will increase the demand for fair asset valuation services.

The present invention provides asset owners a way to identify a fair asset price without having to rely on a local expert's opinion. This is accomplished using blockchain technology and gamification techniques described herein.

### SUMMARY

With the maturing of blockchain, peer-to-peer collaboration software, and networking technologies, it is now possible to facilitate collaborative discovery processes like asset valuation. Asset valuation is a complex and chaotic process typically requiring field expertise and an active marketplace where buyers and sellers are subjected to offer and demand pressures.

The present invention, referred to herein as the Appraiser Network (AN) uses gamified incentives to attract the vast online population to participate in the asset valuation process. The invention attracts assessors and rewards them for sharing their estimate of the valuation of an asset, digital or physical. In some embodiments, machine learning (ML) and/or artificial intelligence (AI) can be used to provide a reward and/or reward estimate.

Incentivized collaboration finds its theoretical basis in the academic studies of crowd behaviors. The book The Wisdom of Crowds by James Suroyevsky (2004) proposes four necessary conditions for achieving successful crowd coordination in estimating the value of an asset:
a. Diversity of opinion (all opinions are welcome in the AN).
b. Independence of opinion (the AN rewards real opinions and can further reward a “best” or most reliable opinion).
c. Decentralization of perspectives (the more opinions, the better).
d. Date aggregation (the AN calculates fair value from all opinions together).

The AN uses P2P technologies to implement a process that achieves the conditions above toward the specific goal of providing a fair valuation for an asset. One of the key challenges in a P2P system is the design of a reward system. Rewards need to embody enough incentive for users to contribute estimates to the protocol, yet remain low enough for paying users to obtain a fast and accurate estimate from the protocol. The speed of resolution will obviously be proportional to the incentive reward offered by the paying user. In some embodiments, ML and/or AI can be used to provide a reward and/or reward estimate.

As a result, the invention replaces the need to find a marketplace for asset pricing and provides a faster and cheaper method to determine a fair price for an asset.

Some embodiments of the invention relate to a method for valuing an asset. In some embodiments, the method can include receiving documented evidence regarding a physical or digital asset. In some embodiments, the method can include transmitting the documented asset evidence to an AN, wherein the AN can include one or more users capable of reviewing the asset evidence and submitting an appraisal bid, logic to facilitate aggregation of appraisal bids, an immutable ledger on which appraisal bids are received and which secures system operations, reputation scoring capabilities which aggregate information over time, comprising.

In some embodiments, the method can include assigning a reputation score to each AN user, wherein the score can be up or down modified by for example a user's reputational information, feedback from other users, and/or appraisal bid success rate. In some embodiments, the method can include receiving and aggregating appraisal bids from the AN, including capturing appraisal bids from one or more users via one or more interface, aggregating the appraisal bids, weighting scores according to the reputation score of each user submitting an appraisal bid, and analyzing the aggregation of appraisal bids for asset valuation.

In some embodiments, the method can include receiving physical or digital documentation regarding asset value and/or sale price. Likewise, in some embodiments, the method can include rewarding one or more users on the AN by a reward engine, including an incentive structure for participation and/or accurate appraisal bids, customization of a plurality of reward options, and weighting user scores based on comparison analysis of bids with asset value and/or sale price. In some embodiments, the method can include machine learning and/or artificial intelligence to provide a reward and/or reward estimate.

In some embodiments, the method can include retaining bidding status and data over time in a secure, immutable ledger for auditing purposes. In some embodiments, the asset can for example include currency, digital currency, non-fungible tokens (NFTs), legal instruments (e.g., title to any tangible or intangible asset such as real estate, motor vehicles such as cars or boats), stocks, bonds, intellectual property (e.g., patents, trade secrets), art, tickets, coupons, tokens (such as casino tokens), notes, banking accounts, digital currency wallets, contracts, promissory notes, private keys, public keys, or any item with documentable value, a group or portfolio of such assets, and/or the like. In some embodiments, the asset is self-validating (has an accepted value). Likewise, in some embodiments, the asset is not self-validating (e.g., wherein the asset comprises title) and wherein documented evidence of the asset comprises more than one form of documentation for verification of a user and/or the asset.

In some embodiments, the documented asset evidence can include for example physical identification, biometric data, witness evidence, multimedia evidence, bank statements, legal documents, chain of title and/or provenance, reputation score, any physical documentation relating to the user and/or the asset., and/or the like. In some embodiments, assigning a reputation score to each AN user includes for example internal and/or external inputs, public and/or private inputs, input from gamification within the network, and/or the like.

In some embodiments, the user's reputational information can include for example the user activity, profile completion, historical bid success rate, accuracy over time, documented educational and/or professional experience, and/or the like. In some embodiments, certain methods further include that users have access to an interface for scoring other users, optionally wherein different scoring interfaces are available for different user types. In some embodiments, the reward options can include for example currency (fiat, crypto, etc.), points, tokens, increased reputation score, and/or the like.

In some embodiments, rewarding one or more users on the AN after receiving physical or digital documentation regarding asset value and/or sale price can further include a feedback loop which increases accuracy of future bids from the AN. In some embodiments, certain methods further include an asset-management system that provides on-location cryptographically secure asset digitization. In some embodiments, the system is adapted for handling of one or more items of at least one asset type. In some embodiments, the system can include a user interface. In some embodiments the system can include an intake portal.

In some embodiments the intake portal can for example be adapted to receive documented evidence of one or more assets, and capture or assign a unique identifier for the asset. In some embodiments, the system can include a processor adapted to receive, process, and/or transmit said asset unique identifier. In some embodiments, the system can include a cryptographically secure immutable digital asset ledger for storing documented evidence of the asset. In some embodiments, the system can include a means of providing a cryptographically unique proof of record. In some embodiments, the user interface and the intake portal can for example be present on a single device. Likewise, in some embodiments, the user interface and the intake portal can for example be present on separate devices.

In some embodiments, the user interface can for example be implemented by an interaction between a machine and a user. In some embodiments, the user interface can include for example an app for a mobile device, a camera, a screen, a computer program, a physical key, and/or the like. In some embodiments, the intake portal can include for example document imaging technology to provide the system with documented evidence of an asset. In some embodiments, the intake portal comprises a scanner. In some embodiments, the intake portal captures the unique identifier present on the asset if the asset is self-validating, or creates a new unique identifier if the asset is not self-validating. In some embodiments, the processor cryptographically secures the documented evidence captured by the intake portal by generating the unique digital signature of the evidence using a hashing function.

In some embodiments, the output of the hashing function can for example be posted to an immutable digital asset ledger, thereby securing the integrity of the documented evidence received by the input portal. In some embodiments, the asset unique identifier can for example be saved locally and on the immutable digital asset ledger. In some embodiments, the immutable digital asset ledger can include a system inventory of multiple asset items present in the system.

In some embodiments, the asset unique identifier can include the item's value denomination. In some embodiments, the asset is not currency. Likewise, in some embodiments, at least one of the asset types is not currency. In some embodiments, certain methods further include a physical or digital wallet storing the cryptographically unique proof of record. In some embodiments, the asset unique identifier can for example be unique to each asset item within an asset type, such that each asset item of a given asset type is distinguishable from every other item of said asset type.

In some embodiments, the system can provide on-location cryptographic validation of a digital asset, wherein the system recognizes an immutable ledger in which the digital asset is registered and uses the ledger of record to validate the authenticity of the digital asset.

In some embodiments, the digital asset can for example be subject to a valuation adjustment factor. In some embodiments, the valuation adjustment factor can for example be based on at least one of asset type, strength and/or quality of evidence, reputation of the user, network appraisal, and/or the like.

In some embodiments, the system provides on-location cryptographically secure exchange of assets. In some embodiments, the exchange of assets involves a user exchanging assets from one type to another. In some embodiments, the exchange of assets involves a user exchanging assets to another individual.

In some embodiments, machine learning and/or AI are used in one or more steps of the method. Likewise, in some embodiments, machine learning and/or AI are used to assign a reputation score to each AN user. In some embodiments, machine learning and/or AI are used to weight scores according to the reputation score of each user submitting an appraisal bid. Further in some embodiments, machine learning and/or AI are used to analyze the aggregation of appraisal bids for asset valuation. Likewise, in some embodiments, machine learning and/or AI are used to weight user scores based on comparison analysis of bids with asset value and/or sale price.

Some embodiments of the invention relate to an asset inventory system or asset digital repository system employing any of the features recited herein. Some embodiments of the invention relate to an asset exchange system employing any of the features recited herein. Some embodiments of the invention relate to an asset-collateralized banking system, comprising any of the features recited herein. Some embodiments of the invention relate to a marketplace for buying, selling, or trading an asset, comprising any of the features recited herein.

Some embodiments of the AN can employ and interact with systems, devices, and solutions for handling cash or quasi-cash items, and other assets, such as digital assets, in such a way as to substantially eliminate employee theft, error, or difficulties in reconciling a record of transactions with a total amount of money in a cash drawer. One such exemplary system is described in U.S. Pat. No. 11,315,380, entitled DIRECT-SCAN CASH-MANAGEMENT SYSTEMS AND METHODS, issued on Apr. 26, 2022, which is incorporated herein by reference in its entirety, and which is referred to herein as the Cash-Management System, or CMS. In such embodiments of the invention, the AN can be integral to, or can dynamically interact with (such as by app-based communications between the AN and the CMS. Likewise, embodiments of the invention can also interact with the invention disclosed in International Patent Application No PCT/US2022/073745, entitled DIRECT-SCAN CASH-AND DIGITAL ASSET-MANAGEMENT SYSTEMS AND METHODS, filed on Jul. 14, 2022, which is incorporated herein by reference in its entirety, and which is referred to herein as the Cash and Digital Asset-Management System, or CDAMS.

Where the AN interacts with other asset-management systems, such as, for example, the CMS and/or the CDAMS, digital assets can be stored as either fungible or non-fungible assets; for example, fungible assets can be stored in common as a balance of value under an account number, whereas non-fungible assets are held uniquely and cannot be sub-divided in smaller units. Bitcoin is a fungible asset; a collectible sword in a virtual world is a non-fungible asset; both digital assets could be offered as input in some embodiments.

In situations in which the AN is facilitated by physical interaction with a system to receive tangible items, the CMS and/or the CDAMS, and/or other systems having similar capabilities can provide such function.

### BRIEF DESCRIPTION OF THE DRAWINGS

FIG. 1 depicts one embodiment of the AN, with inputs from a buyer and an asserted fair price. This illustrates an exemplary embodiment of the invention wherein a network of appraisers is established and used to value an asset. In this embodiment, information about a physical or digital asset is input into a system for an appraisal request. The appraisal request, including the asset information, is conveyed to a network of appraisers. The AN includes one or more appraisers and can be used to crowdsource to give a best estimate as to the value of an asset or item, wherein users in the AN review the asset information and submit an appraisal estimate. An item value appraisal report can then be generated based on the appraisal valuations submitted by the appraisers. Once the asset is sold or otherwise formally valued from a platform outside of the AN, documentation of the asset price can be conveyed to the network, e.g., in the form of physical or digital documentation, in a feedback loop. One or more users in the AN can then be rewarded on the platform for having a successful or accurate asset valuation or bid; in this way, participation and accuracy on the AN are both incentivized.

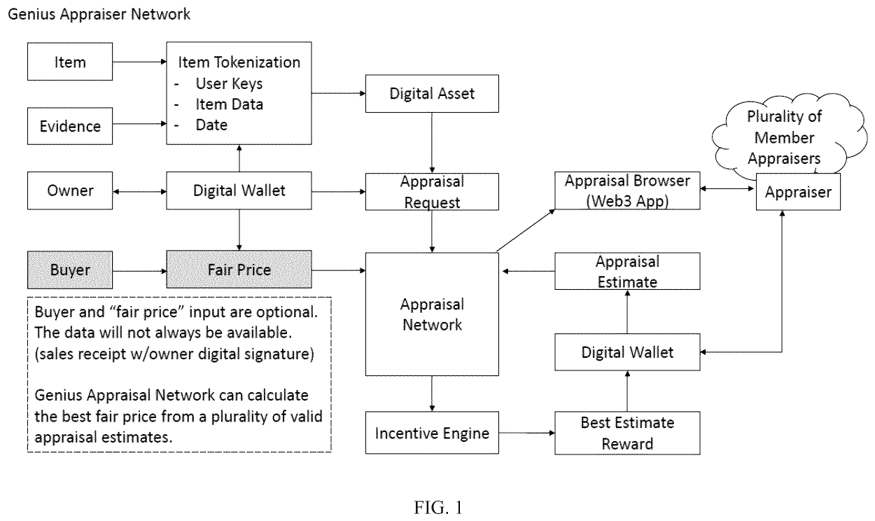

FIG. 2 depicts another embodiment of the AN, with possible inputs from one or more buyers in a marketplace and fair price being determined by inputs from buyers and/or the network of appraisers. When sales price information or evidence is not available, the best fair price is calculated from the plurality of appraisal estimates submitted to the network. The reward engine can include one or more of various reward options, such as monetary rewards (using fiat and/or digital currency), points, tokens, increased user score, etc. A reward can be displayed on the appraiser profile, which indicates the appraiser's experience, reputation score, and appraisal history. A reward can also be deposited into a “wallet” for the appraiser on the platform, where the wallet can include currency (fiat, crypto), tokens, points, and/or other signifiers of value on the system. The platform can retain bidding status and data over time in a secure, immutable ledger for auditing purposes.

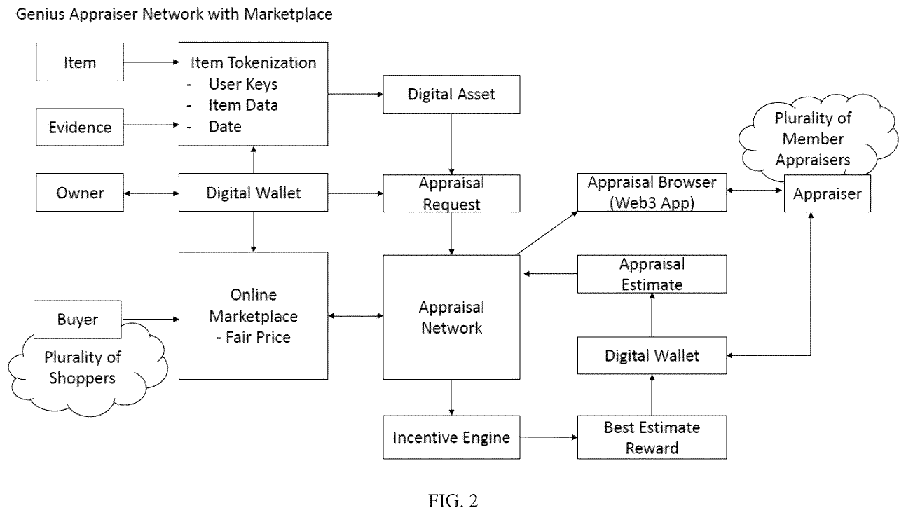

### DETAILED DESCRIPTION

In an exemplary embodiment of the invention the system comprises a means of digitizing and storing an asset, or some form of documentation of an asset, input into the system. The system provides a transaction receipt to the user, including keys allowing the user to demonstrate ownership of and access the digitized asset held by the system. The transaction can be recorded on a blockchain. The asset can then be digitized into an NFT and placed into a digital asset repository (e.g., a vault of crypto keys). The asset optionally can then be held internally by the system or can be physically transferred out of the system to another location, which can be onsite or offsite. The owner of the digital asset repository or crypto keys vault then reviews the asset and conducts offline curation and selection, which can include valuation, pricing, authentication, and various steps to establish the provenance and/or pricing and/or marketing strategy for the asset. The owner of the digital asset repository or crypto keys vault then can communicate the digitized asset to a third-party marketplace or auction house for resale. Information about a physical or digital asset is input into a system for an appraisal request. The appraisal request, including the asset information, is conveyed to a network of appraisers. The AN includes one or more appraisers and can be used to crowdsource a best estimate as to the value of an asset or item, wherein users in the AN review the asset information and submit an appraisal valuation, or bid. An item value appraisal report can then be generated based on the appraisal valuations submitted by the appraisers. Once the asset is sold or otherwise formally valued from a platform outside of the AN, documentation of the asset price can be conveyed to the network, e.g., in the form of physical or digital documentation, in a feedback loop. One or more users in the AN can then be rewarded on the platform for having a successful or accurate asset valuation or bid; in this way, participation and accuracy on the AN are both incentivized. The reward engine can include one or more of various reward options, such as monetary rewards (using fiat and/or digital currency), points, tokens, increased user score, etc. A reward can be displayed on the appraiser profile, which indicates the appraiser's experience, reputation score, and appraisal history. A reward can also be deposited into a “wallet” for the appraiser on the platform, where the wallet can include currency (fiat, crypto), tokens, points, and/or other signifiers of value on the system. The platform can retain bidding status and data over time in a secure, immutable ledger for auditing purposes. In some embodiments, ML and/or AI can be used to provide a reward and/or reward estimate.

In a further exemplary embodiment of the invention, the system comprises a means of digitizing and storing an asset, or some form of documentation of an asset, input into the system. The system provides a transaction receipt to the user, including keys allowing the user to demonstrate ownership of and access to the digitized asset held by the system. The transaction can be recorded on a blockchain. The asset can then be digitized into an NFT and placed into a digital asset repository (e.g., a vault of crypto keys). The asset optionally can then be held internally by the system or can be physically transferred out of the system to another location, which can be onsite or offsite. The owner of the digital asset repository or crypto keys vault then reviews the asset and conducts offline curation and selection, which can include valuation, pricing, authentication, and various steps to establish the provenance and/or pricing and/or marketing strategy for the asset. The owner of the digital asset repository or crypto keys vault then can communicate the digitized asset to a third-party marketplace or auction house for resale. Information about a physical or digital asset is input into a system for an appraisal request. The appraisal request, including the asset information, is conveyed to a network of appraisers. The AN includes one or more appraisers and can be used to crowdsource to give a best estimate as to the value of an asset or item, wherein users in the AN review the asset information and submit an appraisal valuation, or bid. An item value appraisal report can then be generated based on the appraisal valuations submitted by the appraisers. Once the asset is sold or otherwise formally valued from a platform outside of the AN, documentation of the asset price can be conveyed to the network, e.g., in the form of physical or digital documentation, in a feedback loop. One or more users in the AN can then be rewarded on the platform for having a successful or accurate asset valuation or bid; in this way, participation and accuracy on the AN are both incentivized. The reward engine can include one or more of various reward options, such as monetary rewards (using fiat and/or digital currency), points, tokens, increased user score, etc. A reward can be displayed on the appraiser profile, which indicates the appraiser's experience, reputation score, and appraisal history. In some embodiments, ML and/or AI can be used to provide a reward and/or reward estimate. A reward can also be deposited into a “wallet” for the appraiser on the platform, where the wallet can include currency (fiat, crypto), tokens, points, and/or other signifiers of value on the system. The platform can retain bidding status and data over time in a secure, immutable ledger for auditing purposes. The system further comprises a marketplace where buyers can review, purchase, or bid on the digitized asset via the third-party auction house or marketplace. The purchaser or winning bidder then makes payment for and receives the asset, after which time the payment is verified and conveyed to the user who originally input the asset. Upon receipt and acceptance of payment, user has the payment, and the ownership of the asset is now with the buyer, and evidence of the new ownership can be recorded on the blockchain.

The AN can be designed to accommodate a remarkably broad spectrum of asset types, extending its valuation and exchange capabilities far beyond conventional categories to encompass both physical and digital forms, each with tailored digitization, valuation, and exchange protocols. For instance, currency, whether fiat or digital, can be digitized by recording its serial number or blockchain transaction ID, valued against current exchange rates, and exchanged through integrated digital wallets. NFTs, representing unique digital or physical items, are digitized by their blockchain addresses and metadata, valued based on market trends, rarity, and associated real-world utility, and exchanged directly on the AN's marketplace or integrated third-party NFT platforms. Legal instruments, such as real estate deeds, vehicle titles, or corporate shares, are digitized by scanning and cryptographically hashing the physical document, with the hash recorded on the immutable ledger as a unique digital proof of record; their valuation involves expert appraisal considering market comparables and legal encumbrances, and exchange can be facilitated via smart contracts that transfer the digital proof of record upon payment. Intellectual property, including patents, trademarks, and copyrights, is digitized by registering its official documentation and unique identifiers; valuation considers market potential, licensing revenue, and legal enforceability, with exchange often involving complex conditional transfers managed by smart contracts. Art and collectibles, ranging from paintings to rare coins, are digitized through high-resolution imaging, 3D scanning, and detailed provenance documentation; their valuation relies heavily on expert appraisal, historical sales data, and authenticity verification, with exchange potentially involving physical escrow services alongside digital transfer of ownership. Different embodiments of the AN's handling of assets involve self-validating assets and non-self-validating assets. Self-validating assets, such as publicly traded stocks or established cryptocurrencies, possess an inherent, readily accepted market value and require minimal external verification beyond their digital identifiers. Conversely, non-self-validating assets, like a private real estate deed or a unique antique, necessitate a more rigorous process. For these, the system mandates multiple forms of documented evidence for verification of both the asset and the asset originator, which can include physical identification, biometric data, witness evidence, comprehensive multimedia evidence (e.g., high-resolution photos, videos from various angles), bank statements, legal documents, a verifiable chain of title or provenance, and an established user reputation score; this multi-layered verification ensures the integrity and authenticity of the asset before it enters the appraisal process. Beyond individual assets, the AN is equipped to handle and value asset portfolios, which are groups of diverse assets owned by a single entity. The system aggregates the individual valuations of each asset within the portfolio, applying sophisticated algorithms that account for interdependencies, diversification benefits, and overall market exposure to provide a comprehensive portfolio valuation. This allows users to understand the aggregated value and risk profile of their entire holdings.

Furthermore, the AN's adaptable framework opens doors to numerous new industries and applications. In supply chain finance, the system can value inventory, raw materials, or goods in transit, enabling real-time collateralization and financing. For the insurance industry, it provides rapid, verifiable asset valuations for policy underwriting, claims assessment, and fraud prevention. In legal settlements and divorce proceedings, the AN can offer impartial and cryptographically verifiable valuations of complex or unique assets, streamlining equitable distribution. Moreover, it can serve private equity and venture capital firms for valuing illiquid assets within their portfolios, and facilitate peer-to-peer lending by providing transparent, crowd-sourced valuations for collateral. These expanded applications underscore the versatility and transformative potential of the AN across various economic sectors.

The AN is intricately integrated with blockchain technology and cryptocurrency, forming the secure and transparent backbone of its operations. This integration extends far beyond merely tracking appraisal bids, leveraging the immutable and programmable nature of distributed ledgers to automate critical processes and foster a robust digital economy. Smart contracts, self-executing contracts with the terms of the agreement directly written into code, are fundamental to this expanded functionality. Beyond recording appraisal bids, smart contracts are deployed for automated reward distribution, where predefined conditions (e.g., an appraiser's bid accuracy reaching a certain threshold relative to the final asset sale price) automatically trigger the release of rewards (monetary, tokens, or points) to the appraiser's digital wallet without manual intervention. This ensures timely and indisputable payouts, directly incentivizing accurate participation. Furthermore, smart contracts facilitate escrow services for asset exchange. When an asset is listed for sale on the AN's integrated marketplace, a smart contract can hold the digitized asset (e.g., an NFT representing a physical deed) and the buyer's payment in escrow. Upon verification of payment and satisfaction of all predefined conditions (e.g., successful transfer of asset ownership on an external ledger, if applicable), the smart contract automatically releases the asset to the buyer and the payment to the seller. This eliminates the need for trusted third-party intermediaries, reducing costs and mitigating fraud. More advanced conditional asset transfers can also be programmed, such as releasing portions of an asset's value to an originator over time based on performance milestones, or transferring ownership only upon the fulfillment of specific appraisal criteria or market conditions.

The crypto appraisal network token (let's refer to it as “AppraisalCoin” or “APC” for clarity in this disclosure) serves as the native utility token of the AN ecosystem, designed to align incentives and power various network functions. Its primary utility includes: payment for appraisal requests by asset originators, staking by appraisers to gain higher reputation or access premium appraisal opportunities, and governance participation in a Decentralized Autonomous Organization (DAO) model. The value of APC is determined by market forces of supply and demand, influenced by the overall activity on the AN, the volume of appraisals, and the perceived utility and scarcity of the token. To maintain its value and stability, the system employs a dynamic emission schedule where new APC tokens are minted as rewards for accurate appraisals and network participation, often with a decaying rate over time to control inflation. Conversely, burning mechanisms are implemented, such as a percentage of appraisal fees being used to buy back and permanently remove APC from circulation, or a portion of tokens being burned when specific network milestones are achieved. This deflationary pressure helps to offset emissions and support token value. APC interacts seamlessly with other cryptocurrencies (e.g., ETH, stablecoins) and fiat currencies via integrated exchange functionalities, allowing users to convert between them for payment, rewards, or off-ramping.

The immutable ledger underpinning the AN is implemented using a consortium blockchain model. This choice provides a balance between the transparency of a public blockchain and the controlled environment of a private blockchain. Participants in the consortium (e.g., the AN operator, major financial institutions, certified appraisal organizations) operate nodes, contributing to the network's security and validation. The consensus mechanism employed is a modified Proof-of-Stake (PoS) or Delegated Proof-of-Stake (DPoS) variant, where validators are chosen based on their stake in APC and their reputation within the network, ensuring efficient and secure transaction validation without excessive energy consumption. Data integrity is ensured through cryptographic hashing of all documented evidence and appraisal bids, with each hash timestamped and immutably recorded on the blockchain. Any alteration to the original data would result in a different hash, immediately invalidating the record and alerting the network. This cryptographic proof of record, combined with the distributed nature of the ledger, makes tampering virtually impossible and provides an auditable trail for all asset valuations and related transactions.

Interoperability is a key design principle, allowing the AN to seamlessly integrate with existing asset-management systems, notably the Cash-Management System (CMS) and the Cash and Digital Asset-Management System (CDAMS) as described in the incorporated U.S. Pat. No. 11,315,380 and International Patent Application No. PCT/US2022/073745. This interaction occurs through secure, standardized communication protocols, primarily via authenticated API (Application Programming Interface) endpoints. For instance, when a physical asset is digitized by a CMS or CDAMS unit, the unique digital signature and metadata generated by these systems are transmitted to the AN via a secure API call. The AN then uses this information to initiate an appraisal request. Conversely, once an asset valuation is completed by the AN, the determined fair price and relevant appraisal report data can be pushed back to the CMS/CDAMS for integration into their inventory management or transaction processing workflows. Data exchange mechanisms utilize industry-standard formats such as JSON (JavaScript Object Notation) or XML, ensuring compatibility and efficient parsing between disparate systems. This allows for a holistic ecosystem where assets can be physically managed, digitally represented, valued by a decentralized network, and then seamlessly integrated into financial or exchange operations, eliminating silos and enhancing overall operational efficiency.

An auction house in general is a public place where buyers are invited to come and look, or browse as on eBay, which has a database of assets. A separate digital assets repository can be created at a physical or online auction house or marketplace location. The NFT stamp which represents the unique digital asset is the digital twin of the physical asset, such as the paper car title. When a digital stamp is stored in a local database, it is usually called a crypto wallet. It is a wallet because it contains the keys that control the asset, and it is the owner that proves the ownership of the asset. When, for example, a car title is inserted into the system, it is now stored in the system's digital wallet.

The digitized asset stored in the system can be called back, but is stored in the system until that time, such that a transaction involving a digital asset and a marketplace or auction house may never involve the asset physically going to the marketplace or auction house. It is expected that a third party, such as, for example, a third-party bank, may host the system or network of systems, and therefore would host the system storing the digitized asset.

The third party hosting the system or network of systems can monitor the digital assets repository whenever something new comes into the system, in order to verify the asset before showing it to anyone or before even valuing it. This could be fully remote, such as, for example, someone in China, managing a casino in Las Vegas. In this scenario, when a new digitized asset such as, for example, a car title, is received into the system, the individual in China can review the asset, zoom in on the data, call the DMV to verify, and various other authentication steps which could lead to an approval process.

The asset entered into the system can also be, for example, a smart contract. In the case of smart contracts, whenever a digital asset is moved into the digital asset repository, it effectively creates a smart contract. The smart contract created in this fashion can have ifs and thens and can be tended to as an asset, which itself has value; for practical purposes, it may be useful to set a minimum value for a contract entered into the system, such as, for example, $10,000. Such a smart contract can be reviewed by a high-level individual within the organization managing the system or network of systems, and the smart contract can be sent to that individual for review. An individual can go to the system and look at the contract to verify its value. Using cryptocurrency and blockchain technology allows the process to be programmed to address the conditions for the flow of unique value.

Embodiments of the invention also encompass the establishment and use of a network of appraisers (also referred to herein as an appraiser network or AN) to value an asset, once information about a physical or digital is input into a system. Asset information can include, for example, evidence of ownership of the asset, photographs, titles, documentation of the asset and its condition, other appraisals, purchase receipts or documentation, documentation of sale price and/or valuation of similar items, and the like. The AN includes one or more users and can be used to crowdsource to give a best estimate as to the value of an asset or item, wherein users in the AN review the asset information and submit an appraisal valuation, or bid. The appraisal valuations or bids received from the users on the AN are aggregated and documented, for example on an immutable ledger which receives appraisal bids and secures system operations. The platform can determine the average valuation range and/or can value the asset as a consensus value range. The asset can also include a group of assets, or an asset portfolio. ML and/or Al platforms can optionally be deployed to facilitate optimization of one or more fee structure in real-time based on current network conditions and demand for services.

Use of ML and/or (AI) to manage the reward structure of a P2P network protocol provides a significant improvement over currently known P2P networks, such as Bitcoin, for example. In Bitcoin, the rewards (transaction fees) are determined by the paying users. Bitcoin also includes two other important (but hardcoded) mechanisms, namely block rewards and mining difficulty adjustment algorithms.ML and/or AI models to enhance the accuracy, efficiency, and fairness of asset valuation, appraisal aggregation, and appraiser incentivization. Rather than broad application, specific ML models can be deployed for distinct functions within the system.

### Exemplary Appraisal Aggregation and Consensus Building Models

Ensemble Models (e.g., Random Forests, Gradient Boosting Machines): These models are used to synthesize multiple appraisal bids into a single, robust valuation. By combining the outputs of several decision trees, they can account for the diversity in appraiser opinions, identify outliers, and arrive at a more resilient consensus value.

Neural Networks (e.g., Multi-Layer Perceptrons): For more complex assets where subtle patterns in appraiser behavior or asset characteristics influence valuation, neural networks can be employed to learn non-linear relationships between individual bids, appraiser reputation, and the final asset value.

### Reputation Scoring and Performance Evaluation Models

Regression Models (e.g., Linear Regression, Support Vector Regression): Used to predict an appraiser's future accuracy based on their historical performance, bid deviations, and participation metrics.

Classification Models (e.g., Logistic Regression, Support Vector Machines): To categorize appraisers into performance tiers (e.g., high accuracy, moderate, low accuracy) or to identify potential patterns of fraudulent or inaccurate bidding behavior.

### Fraud Detection and Anomaly Identification Models

Clustering Algorithms (e.g., K-Means, DBSCAN): To identify unusual patterns in bidding behavior that might indicate collusion or malicious intent among appraisers, segmenting bids into normal and anomalous groups.

Isolation Forests or One-Class SVMs: Specifically designed for anomaly detection, these models can quickly pinpoint bids or appraiser activities that deviate significantly from established norms.

### Automated Asset Assessment and Feature Extraction Models

Convolutional Neural Networks (CNNs): Primarily for image and video analysis (as detailed below), to extract relevant features from visual media of physical assets.

Natural Language Processing (NLP) Models (e.g., BERT, Transformers): To parse and understand textual descriptions of assets, historical context, legal documents, and appraiser justifications, extracting key entities, sentiments, and relationships that contribute to valuation.

Optionally a sophisticated, yet simple autonomous AI agent can operate within the AN, continuously monitoring network activities and making real-time, data-driven recommendations and determinations by constantly monitoring appraisal request data (new asset submissions, urgency, requirements), appraiser performance data (real-time reputation, historical accuracy, bid frequency, availability), market data (external trends, historical sales, economic indicators, cryptocurrency fluctuations), and network health metrics (appraisal volume, completion times, user engagement)

Based on the monitored data, the AI agent dynamically suggests optimal asset assessment fees to asset originators considering asset complexity, required expertise, appraisal urgency, current appraiser supply and demand, and historical fee data. Furthermore, the AI agent plays a pivotal role in determining and providing rewards for accurate appraisers by comparing bids to the final asset value, calculating accuracy metrics (e.g., percentage deviation), adjusting appraiser reputation scores based on bid accuracy and consistency, allocating precise monetary, token, or point rewards using a reward function that inputs accuracy, reputation, asset complexity, and appraiser tier, and finally, triggering the automated distribution of these rewards to appraisers' digital wallets via smart contract integration upon verification of accuracy and appraisal cycle completion.

Robust valuation within the AN can rely on comprehensive feature engineering, transforming raw data into meaningful inputs for ML/AI models. These can include: asset type (categorical features for type and sub-type), evidence quality (quantitative features assessing completeness and quality of multimedia and documentation, potentially with an Al-assigned “quality score”), user reputation (numerical features for real-time score, accuracy history, and tier level to weight bid influence), historical sales data (time-series features from past transactions of similar assets, including price, volatility, volume, and recency), market trends (external economic indicators, industry indices, and NLP-extracted news sentiment), asset-specific attributes (customized features based on unique characteristics like artist, specifications, or property features), and bid characteristics (features derived from bids themselves, such as initial bid spread and appraiser participation count).

These engineered features are then fed into ML/AI models for appraisal aggregation (predicting accurate aggregated value) and reward estimation (determining likelihood of accurate bids for reward calculation). Given the importance of trust and transparency in asset valuation, the AN incorporates principles of Explainable AI (XAI), providing transparency in aggregation by showing insights into why a value was reached, including weighting factors for appraiser bids based on reputation, highlighting influential features (e.g., specific images, documentation, historical sales data) that contributed significantly to the AI-derived valuation, and displaying deviation analysis of individual appraiser bids from the final aggregated value. Reward Justification ensures appraisers receive clear explanations for reward calculations, including accuracy score breakdowns, factors influencing reputation changes, and transparent display of tier progression criteria. Model Interpretability employs techniques like SHAP or LIME to provide local explanations for specific valuation predictions or reward determinations, allowing users to understand the model's reasoning for a single instance, fostering user confidence and facilitating dispute resolution.

For physical assets, advanced image recognition and processing techniques are fundamental for automated feature extraction and preliminary valuation, encompassing image classification/recognition for initial asset categorization directly from images, brand/maker recognition, and aiding in authentication/verification by comparing images against databases of authentic items; object detection identifies and localizes specific components or features, assesses visible damage, and automatically extracts attributes like color or texture; the types of features extracted from images include low-level features (edges, corners, colors, textures), mid-level features (aggregations of low-level features representing parts of objects), and high-level features (semantic features from deep learning models capturing meaning like “genuine Rolex watch face” or “Impressionist style”). These features contribute to valuation by assessing condition, indicating authenticity signals, providing descriptive attributes (size, material, markings), and enabling comparative analysis against large datasets of similar assets with known market values to aid in initial estimation.

In current P2P protocols, it is the role of the protocol designer to define a formula that will encourage participation in the protocol's activities. This disclosure therefore has a need for incentives and a reward mechanism for participating users.

Instead of hardcoding reward formulas in the protocol itself, the system of the present disclosure can be augmented with a simple autonomous AI agent that can monitor current network conditions and offer suggestions to paying users for asset assessment, and can provide a reward for the most accurate estimating user. The AI-assisted reward amount can optionally include a “timing” parameter, allowing users to request for faster (higher reward) or longer-duration (lower reward) estimation periods.

Exemplary user interfaces relevant to the present invention are well known to those skilled in the art and can follow standard Bitcoin and crypto-currency wallet fee suggestion models, which also include a “fast/slow” transaction speed option. In some embodiments, ML and/or AI can be used to provide a reward and/or reward estimate instead of simple hardcoded calculation tables.

The Appraiser Network (AN) can be designed with an intuitive and efficient user interface (UI) and a seamless user experience (UX) to facilitate all interactions, from asset submission to appraisal and reward management. The platform emphasizes clarity, accessibility, and robust functionality across its various modules. The core functionalities of the AN are supported by well-defined UI flows, ensuring a logical and user-friendly progression for both asset originators and appraisers.

### Exemplary Asset Submission Flow (for Asset Originators)

Initiation: Upon logging in, the user selects “Submit New Asset for Valuation” from their dashboard or a prominent navigation menu. Asset Identification: A form prompts the user to categorize the asset (e.g., Physical, Digital, Intellectual Property, Financial Instrument). Based on the category, dynamic fields appear.

Basic Information Input: Users input fundamental details such as asset name, brief description, estimated value range (optional, for guidance), and desired appraisal urgency. Multimedia Evidence Upload: This step allows users to upload high-resolution images, videos, audio files, or 3D scans of the asset. For digital assets, this includes links to blockchain explorers, smart contract addresses, or file hashes.

Documentation Attachment: Users can attach supporting documents like purchase receipts, certificates of authenticity, provenance records, legal titles, deeds, or any other relevant paperwork (e.g., in PDF, DOCX format).

External Data Integration: The UI provides options to link to external data sources. This could involve API integrations for pulling data from e-commerce platforms (e.g., past sales on eBay for collectibles), real estate databases (MLS), or publicly verifiable records. Appraisal Request Configuration: The user specifies the type of appraisal desired (e.g., quick estimate, detailed valuation, legally binding appraisal), the currency for appraisal fees, and any specific appraisal instructions.

Review and Confirmation: A summary screen displays all entered information for review. The user confirms accuracy and agrees to the terms and conditions before submitting the asset for appraisal.

### Exemplary Appraisal Request Flow (for Appraisers)

Notification/Discovery: Appraisers are notified of new appraisal requests via their dashboard, email alerts, or push notifications.

Request Review: Clicking on an appraisal request directs the appraiser to a dedicated screen displaying the asset's information, multimedia evidence, supporting documentation, and appraisal instructions.

Bid Submission: Appraisers enter their appraisal bid (the estimated value of the asset) within a specified timeframe. The UI clearly indicates the deadline and the current lowest/highest bids if visible to other appraisers. Justification (Optional/Mandatory): For complex assets or higher-tier appraisals, the UI can require appraisers to provide a brief justification for their valuation, referencing specific data points or market analysis.

Confirmation: The appraiser reviews their bid and submits it. A confirmation message indicates successful submission.

### Exemplary Reward Display Flow

Dashboard Integration: Rewards (monetary, token, points, badges) are prominently displayed on the appraiser's dashboard.

Detailed History: A “Rewards History” section allows users to view a chronological record of all earned rewards, including the associated appraisal request, the type of reward, and the value.

Badge Showcase: A dedicated “Accolades” or “Badges” section visually showcases earned recognition badges, often with descriptions of their criteria and significance.

Wallet Integration: For cryptocurrency rewards, the UI provides a clear link or direct view into the user's integrated digital wallet, showing current balances and transaction history.

### Exemplary Profile Management Flow

Profile Access: Users navigate to “My Profile” or “Settings” from the main menu.

Personal Information: Sections for updating contact details, payment information (bank accounts, crypto wallet addresses), and preferred notification settings.

Expertise and Certifications: Appraisers can update their areas of expertise, upload professional certifications, and link to external professional profiles (e.g., LinkedIn).

Reputation and Performance: A dedicated tab displays their current reputation score, appraisal accuracy statistics, and historical performance metrics.

Security Settings: Options for two-factor authentication (2FA), password changes, and viewing active login sessions.

### Exemplary Appraiser Dashboard

The Appraiser Dashboard serves as the central hub for all appraiser activities, providing an at-a-glance overview of their status and actionable insights. Key components include:

Current Appraisal Requests: A dynamic list or card view of active appraisal requests available for bidding, often filterable by asset type, urgency, or potential reward.

Appraisal History: A comprehensive log of all past appraisals, indicating the asset, their submitted bid, the final determined value, and their accuracy score for each. This section can be sorted and searched.

Reputation Score: A prominently displayed numeric or visual indicator of the appraiser's current reputation score, often accompanied by a trend graph showing recent changes.

Wallet Balance: A clear display of the appraiser's current monetary and token balances, with quick links to withdraw or manage funds.

Notifications: A feed of alerts for new appraisal opportunities, bid results, reward payouts, or system announcements.

Performance Metrics: Quick statistics on their average accuracy, number of appraisals completed, and total earnings over a selected period.

Quick Links: Shortcuts to profile settings, support, and community forums.

### Exemplary Asset Information Input

The asset information input process is designed to capture comprehensive and verifiable data, ensuring a robust foundation for accurate appraisals. The process is guided, often leveraging conditional logic where subsequent fields appear based on previous selections (e.g., selecting “Real Estate” prompts for address, property type, square footage). Input fields utilize validation to ensure data integrity.

### Exemplary Types of Data Captured

Descriptive Data: Asset name, detailed description, condition (e.g., “new,” “used,” “damaged”), dimensions, weight, and relevant historical context.

Categorization Data: Hierarchical categorization (e.g., “Art”>“Painting”>“Oil on Canvas”>“Impressionist”).

Provenance Data: Ownership history, chain of custody, and verifiable past transactions.

Legal and Regulatory Data: For assets requiring legal documentation, fields for patent numbers, copyright registrations, property deeds, or security filings.

Financial Data: Purchase price (if known), insurance value, and any associated liabilities or encumbrances.

Multimedia Evidence: As detailed in the “Asset Submission Flow,” this includes images which can be in format of high-resolution photographs from multiple angles, close-ups of distinguishing features, damage, or authenticity marks. Support can exist for various formats (JPEG, PNG, TIFF). Video which can be in the format of short video clips demonstrating functionality, condition, or scale, particularly useful for mechanical assets or performances. Audio for audio-specific assets (e.g., vintage recordings, musical instruments), audio samples. 3D Scans/Models for highly detailed physical assets, enabling appraisers to virtually inspect the item.

### Exemplary Integration with External Data Sources

API Connectors: Seamless integration with established databases and platforms (e.g., public property records, art market indices, stock exchanges, NFT marketplaces like OpenSea, enterprise asset management systems) to automatically pull verifiable data based on provided identifiers (e.g., VIN for vehicles, ISBN for books, blockchain addresses for digital assets).

Web Scraping (Controlled): For less structured data, controlled and permission-based web scraping mechanisms may be employed to gather publicly available information, with strict validation protocols.

User-Provided Links: Users can provide direct URLs to relevant online listings, news articles, or official records that support the asset's description or provenance.

Once the asset is sold or otherwise formally valued from a platform outside of the AN, documentation of the asset price can be conveyed to the network, e.g., in the form of physical or digital documentation, in a feedback loop. One or more users in the AN can then be rewarded on the platform for having a successful or accurate asset valuation or bid; in this way, participation and accuracy on the AN are both incentivized. The reward engine can include one or more of various reward options, such as monetary rewards (using fiat and/or digital currency), points, tokens, increased user score, etc. The platform can retain bidding status and data over time in a secure, immutable ledger for auditing purposes.

Each user on the AN is subject to reputation scoring, which aggregates information over time and assigns a score to each user. Information which can affect a user's score includes the user's reputational information (such as, for example, the user's activity on the platform, completion of the user profile, the user's historical success rate, the user's bid/valuation accuracy over time, information from the user's curriculum vitae, such as educational and employment history, etc.), feedback from other users, the user's appraisal valuation/bid success rate, etc. The scores can be weighted, for example, by a scoring interface. Different user types can have the ability to weight, add or subtract from, and/or otherwise influence the score of a fellow user, and different user types may have different scoring capabilities and/or different scoring interfaces. A user inputting an asset and requesting a valuation can be scored as well. For example, a user can receive a negative score for poor quality requests/products.

In this way, the AN additionally can be gamified such that users on the network are ranked according to their experience and success rate, and are rewarded for accurate valuations (also referred to herein as bids). The AN thus acts as a social network, which empowers users to use and benefit from their own expertise.

This valuation estimate can be used as a standalone valuation tool anywhere an asset value estimation is useful. The valuation is also particularly useful in the systems as described in the preceding paragraphs, wherein the system can receive an asset, or a digitized representation thereof (such as a type of document, e.g., a deed to house or vehicle, a piece of art, etc.), at a location which is not able to determine a value for the asset, or which is not able to determine a value for the asset at that moment in time. For example, a digitized asset, such as a deed or a piece of art, can be input into the system at a location such as a casino, which has no way of reliably ascribing a value to the asset in a timely fashion (or at all).

The AN can provide a gamified way for the owner of an asset (e.g., a physical or digitized asset, digital wallet, etc.) to get exposure to a group of appraisers in order to determine an accurate value for an asset. In this gamified system, appraisers, or users, play a game of betting on the value for an asset. The system can incentivize non-cheating by rewarding users who have values, or bids, which are the closest to the actual value or sale price of the asset, once the owner of the asset inputs the real-world value or sale price into the system following a sale or other formal or certified valuation.

Successful users can receive a reward on the platform. For example, one type of reward is an increase in the user's ranking and/or reputational score, thereby making the opinion or future valuations or bids from that user more highly weighted. This method of distributing rewards acts to incentivize users to give good, or accurate, values. Other types of rewards can include direct monetary compensation, tradable tokens, or conventional points. This way the Appraiser Network (AN) implements a multi-faceted reward system designed to incentivize comprehensive participation, enhance appraisal accuracy, and foster a robust community of expert appraisers.

Rewards can be structured through tiered rewards and progression systems. Wherein appraisers can ascend through various performance tiers (e.g., Novice, Intermediate, Advanced, Expert, Master Appraiser) based on a combination of factors including the volume of appraisals completed, consistent accuracy, positive peer reviews, and longevity within the network. Each tier unlocks progressively more valuable rewards, which can include the following rewards:

Increased Earning Potential—Appraisers earn a higher percentage of appraisal fees, bonus payouts, or preferential access to high-value appraisal requests.

Enhanced Voting Power—For decentralized governance models, higher-tiered appraisers can be granted increased voting weight in proposals related to network upgrades, policy changes, or dispute resolution.

Early Access—Appraisers can earn exclusive invitations to pilot new features, participate in beta testing for new asset categories, or provide feedback on system enhancements.

Exclusive Access and Privileges—Rewards can extend beyond direct financial incentives to include access to privileged information or functionalities. This could involve premium data insights such as access to aggregated market data, advanced analytical tools, or specialized valuation reports not available to general users. Curated appraisal opportunities such as eligibility for appraisal requests involving rare, highly specialized, or high-value assets, offering unique challenges and potentially higher rewards. Direct engagement with asset originators such as opportunities to consult directly with asset owners or project developers, providing valuable networking and learning experiences. Membership in elite appraisal councils such as invite-only groups for high-performing appraisers to discuss complex valuations, contribute to methodology development, or mentor newer appraisers.

Community Recognition and Reputation Badges—To foster a sense of accomplishment and professional standing within the AN, a system of recognition badges and accolades is implemented. These non-monetary rewards serve as visible indicators of an appraiser's expertise and contribution. Accuracy badges can be awarded for maintaining a high average accuracy rate across a specified number of appraisals, potentially categorized by asset type (e.g., “NFT Valuation Expert,” “Real Estate Accuracy Star”). Participation badges can be awarded for consistent activity, promptness in submitting bids, or active engagement in community forums. Peer-reviewed excellence badges can be granted based on positive feedback from other appraisers or asset owners, indicating a high level of professionalism and trustworthiness. Special achievement badges can be awarded for activities such as identifying novel fraud patterns, developing new valuation methodologies, or successfully appraising highly challenging assets. Public profile enhancements can include display of earned badges, certifications, and a detailed appraisal history on an appraiser's public profile within the network, enhancing their credibility and attracting more appraisal opportunities.

This comprehensive reward framework aims to cultivate a highly engaged, skilled, and trustworthy appraiser community, thereby enhancing the overall accuracy and reliability of asset valuations within the system.

For example, a user may have an asset and may be located at a venue wanting to receive a value or physical currency for the asset (such as, a user at a casino and wanting cash or casino chips in exchange for a motorcycle title). The user can input the title into the system described herein, which digitizes the asset and provides a receipt. The receipt can have a QR code which can be scanned by an app, or by the casino, etc., as well as the digital key(s) which still control ownership (i.e., mathematic proof of ownership), which can be used by the user to force a claim. The system after digitizing the asset has the digital keys to the asset, while the user has the code. The digitized asset can be presented to the AN for a valuation request, which can then provide a value for the item (e.g., how much is item worth in that location, at that moment in time). Members of the AN will see the new valuation request when they interact with the system and can review all information associated with the valuation request. The system is necessarily flexible/adaptable to determine what kind of validating info is necessary before moving forward with the valuation request. Appraisers on the network can submit transactions with their valuations, at some point someone can call a price, or there will be a purchase.

The AN is a form of “smart contract”, with a set of rules. The gamification of the AN acts as a set of tools, to improve accuracy and outcomes. The gamification aspect can provide rewards, such as stars, ratings, rankings, weighting, platform tokens, etc., which in turn improve the quality of the valuations provided by the AN. Submitted appraisals are entered as a smart contract and are tracked on the system or platform. In this system, all valuations and final values or sale prices are recorded on an immutable ledger, such as on a blockchain, for transparency and for auditing purposes.

The user who entered the asset into the system can receive reports from the appraisals. When an actual transaction is completed or a formal valuation is received, the user who entered the asset into the system can submit the actual sale price or formal valuation to identify the best appraisal. The member(s) of the AN with the most accurate valuation can then be rewarded on the platform for having the best valuation. For example, the system can reward the user with, for example, stars, ratings, rankings, weighting, platform tokens (such as, for example, an extra crypto appraisal network token).

In the example having a network which receives and digitizes an asset, and which also includes the AN, the system can further be used as a marketplace, where the asset can receive a valuation and further can be listed for sale on the platform, and potentially purchased, based on the valuation. In this manner, the system can become a marketplace for any digitized asset which can receive a valuation from the AN.

The appraisal network can have its own crypto appraisal network token, which can initially be free but which will have a value published to the network. The system of crypto economics can be used to define the gamified rewards system. The system can use multiple tokens, such as a pricing token, e.g., using an existing crypto currency, and/or the system can operate using its own appraisal network token. Any such token can optionally be priced to the dollar for stability. A currency token can be used on the network such that payments are made using the currency token when a user consumes from the network. For example, a user requesting an appraisal may need to pay a nominal fee in a fiat currency, crypto currency, or currency token created for the network, such as by paying a fee in said currency to input or digitize an item. The charge can convert to cryptocurrency in the AN. The tokens created on the network will be limited in number and therefore will have a value in accordance with the limited amount of currency issued. The currency will be available to users via offers or by rewards received for various actions on the system. The currency value on the network can change over time depending on economics and market factors, such that the system can become a crypto marketplace of NFTs. Users can receive loyalty rewards, e.g., for keeping cash/currency, or assets, in the system for a certain amount of time.

The system can optionally charge a fee for submission of an asset to be valued, and/or the system can additionally be paid a fee or percentage of the item sale price for a successful valuation or bid. When the system becomes a marketplace for transactions involving a digitized asset which receives a valuation from the AN, the system can additionally be paid a fee or percentage of the item sale price, and/or the user with the most accurate valuation or bid can additionally be paid a fee or percentage of the item sale price, in addition to receiving other rewards on the platform for the valuation success and accuracy.

Because individuals (appraisers) can be involved, the system can lend itself to a traditional governance model or to a decentralized autonomous organization (DAO) system of governance. A DAO is essentially a governance loop which brings individuals into aspects of governance, with feedback from the network, such as the AN, and arbitration models.

### Neural Networks

Image classification/recognition generally requires accepting an input image and outputting a class or a probability of classes that best describes the image. This can be done using a computer system equipped with a processing engine, which utilizes algorithms, to process the input image and outputting a result. Image detection can also utilize a similar processing engine, whereby the system accepts an input image and identifies objects of interest within that image with a high level of accuracy using the algorithms pre-programmed into the processing engine.

Regarding the input image, the system will generally orient the input image as an array of pixel values. These pixel values, depending on the image resolution and size, will be an array of numbers corresponding to (length)×(width)×(# of channels). The number of channels can also be referred to as the depth. For example, the array could be L×W×Red Green Blue color model (RBG values). The RGB would be considered three channels, each channel representing one of the three colors in the RGB color model. For example, the system can generally characterize a 20×20 image with a representative array of 20×20×3 (for RGB), with each point in the array assigned a value (e.g., 0 to 255) representing pixel intensity. Given this array of values, the processing engine can process these values, using its algorithms, to output numbers that describe the probability of the image being a certain class (e.g., 0.80 for cell, 0.15 for cell wall, and 0.05 for no cell).

A deep neural network (DNN) generally, such as a convolutional neural network (CNN), generally accomplishes an advanced form of image processing and classification/detection by first looking for low level features such as, for example, edges and curves, and then advancing to more abstract (e.g., unique to the type of images being classified) concepts through a series of convolutional layers. A DNN/CNN can do this by passing an image through a series of convolutional, nonlinear, pooling (or downsampling, as will be discussed in more detail below), and fully connected layers, and get an output. Again, the output can be a single class or a probability of classes that best describes the image or detects objects on the image.

Regarding layers in a CNN, for example, the first layer is generally a convolutional layer (Conv). This first layer will process the image's representative array using a series of parameters. Rather than processing the image as a whole, a CNN will analyze a collection of image sub-sets using a filter (or neuron or kernel). The sub-sets will include a focal point in the array as well surrounding points. For example, a filter can examine a series of 5×5 areas (or regions) in a 32×32 image. These regions can be referred to as receptive fields. Since the filter must possess the same depth of the input, an image with dimensions of 32×32×3 would have a filter of the same depth (e.g., 5×5×3). The actual step of convolving, using the exemplary dimensions above, would involve sliding the filter along the input image, multiplying filter values with the original pixel values of the image to compute clement wise multiplications, and summing these values to arrive at a single number for that examined portion of the image.

After completion of this convolving step, using a 5×5×3 filter, an activation map (or filter map) having dimensions of 28×28×1 will result. For each additional layer used, spatial dimensions are better preserved such that using two filters will result in an activation map of 28×28×2. Each filter will generally have a unique feature it represents (e.g., colors, edges, curves, etc.) that, together, represent the feature identifiers required for the final image output. These filters, when used in combination, allow the CNN to process an image input to detect those features present at each pixel. Therefore, if a filter serves as a curve detector, the convolving of the filter along the image input will produce an array of numbers in the activation map that correspond to high likelihood of a curve (high summed clement wise multiplications), low likelihood of a curve (low summed clement wise multiplications) or a zero value where the input volume at certain points provided nothing that would activate the curve detector filter. As such, the greater number of filters (also referred to as channels) in the Conv, the more depth (or data) that is provided on the activation map, and therefore more information about the input that will lead to a more accurate output.

Balanced with accuracy of the CNN is the processing time and power needed to produce a result. In other words, the more filters (or channels) used, the more time and processing power needed to execute the Conv. Therefore, the choice and number of filters (or channels) to meet the needs of the CNN method are specifically chosen to produce as accurate an output as possible while considering the time and power available.

To enable further a CNN to detect more complex features, additional Conv layers can be added to analyze what outputs from the previous Conv layer (i.e., activation maps). For example, if a first Conv layers looks for a basic feature such as a curve or an edge, a second Conv layer can look for a more complex feature such as shapes, which can be a combination of individual features detected in an earlier Conv layer. By providing a series of Conv layers, the CNN can detect increasingly higher-level features to arrive eventually at the specific desired object detection. Moreover, as the Conv layers stack on top of each other, analyzing the previous activation map output, each Conv layer in the stack is naturally going to analyze a larger and larger receptive field by virtue of the scaling down that occurs at each Conv level, thereby allowing the CNN to respond to a growing region of pixel space in detecting the object of interest.

A CNN architecture generally consists of a group of processing blocks, including at least one processing block for convoluting an input volume (image) and at least one for deconvolution block (or transpose convolution). Additionally, the processing blocks can include at least one pooling block and unpooling block. Pooling blocks can be used to scale down an image in resolution to produce an output available for Conv. This can provide computational efficiency (efficient time and power), which can in turn improve actual performance of the CNN. These pooling, or subsampling, blocks keep filters small and computational requirements reasonable, these blocks coarsen the output (can result in lost spatial information within a receptive field), reducing it from the size of the input by a factor equal to the pixel stride of the receptive fields of the output units.

Unpooling blocks can be used to reconstruct a these coarse outputs to produce an output volume with the same dimensions as the input volume. An unpooling block can be considered a reverse operation of a convoluting block to return an activation output to the original input volume dimension.

However, the unpooling process generally just simply enlarges the coarse outputs into a sparse activation map. To avoid this result, the deconvolution block densifies this sparse activation map to produce both and enlarged and dense activation map that eventually, after any further necessary processing, a final output volume with size and density much closer to the input volume. As a reverse operation of the convolution block, rather than reducing multiple array points in the receptive field to a single number, the deconvolution block associate a single activation output point with a multiple outputs to enlarge and densify the resulting activation output.

It should be noted that while pooling blocks can be used to scale down an image and unpooling blocks can be used to enlarge these scaled down activation maps, convolution and deconvolution blocks can be structured to both convolve/deconvolve and scale down/enlarge without the need for separate pooling and unpooling blocks.

The pooling and unpooling process can be limited depending on the objects of interest being detected in an image input. Since pooling generally scales down an image by looking at sub-image windows without overlap of windows, there is a clear loss in spatial info as the scaling down occurs.

A processing block can include other layers that are packaged with a convolutional or deconvolutional layer. These can include, for example, a rectified linear unit layer (ReLU) or exponential linear unit layer (ELU), which are activation functions that examine the output from a Conv layer in its processing block. The ReLU or ELU layer acts as a gating function to advance only those values corresponding to positive detection of the feature of interest unique to the Conv layer its processing block.

Given a basic architecture, the CNN is then prepared for a training process to hone its accuracy in image classification/detection (of objects of interest). Using training data sets, or sample images used to train the CNN so that it updates its parameters in reaching an optimal, or threshold, accuracy, a process called backpropagation (backprop) occurs. Backpropagation involves a series of repeated steps (training iterations) that, depending on the parameters of the backprop, either will slowly or quickly train the CNN. Backprop steps generally include forward pass, loss function, backward pass, and parameter (weight) update according to a given learning rate. The forward pass involves passing a training image through the CNN. The loss function is a measure of error in the output. The backward pass determines the contributing factors to the loss function. The weight update involves updating the parameters of the filters to move the CNN towards optimal. The learning rate determines the extent of weight update per iteration to arrive at optimal. If the learning rate is too low, the training may take too long and involve too much processing capacity. If the learning rate is too fast, each weight update may be too large to allow for precise achievement of a given optimum or threshold.

The backprop process can cause complications in training, thus leading to the need for lower learning rates and more specific and carefully determined initial parameters upon start of training. One such complication is that, as weight updates occur at the conclusion of each iteration, the changes to the parameters of the Conv layers amplify the deeper the network goes. For example, if a CNN has a plurality of Conv layers that, as discussed above, allows for higher-level feature analysis, the parameter update to the first Conv layer is multiplied at each subsequent Conv layer. The net effect is that the smallest changes to parameters have large impact depending on the depth of a given CNN. This phenomenon is referred to as internal covariate shift.

It should be noted that even though CNNs are spoken about in detail above, the various embodiments discussed herein could utilize any neural network type or architecture.

### Computer-Implemented System

In various embodiments, the systems and methods for valuing an asset can be implemented via computer software or hardware. An exemplary computer system can have various embodiments of the present teachings implemented thereon. In various embodiments of the present teachings, the computer system can include a bus or other communication mechanism for communicating information and a processor coupled with the bus for processing information. In various embodiments, the computer system can also include a memory, which can be a random-access memory (RAM) or other dynamic storage device, coupled to the bus for determining instructions to be executed by the processor. Memory can also be used for storing temporary variables or other intermediate information during execution of instructions to be executed by the processor. In various embodiments, the computer system can further include a read only memory (ROM) or other static storage device coupled to the bus for storing static information and instructions for the processor. A storage device, such as a magnetic disk or optical disk, can be provided and coupled to the bus for storing information and instructions.

In various embodiments, the computer system can be coupled via the bus to a display, such as a cathode ray tube (CRT) or liquid crystal display (LCD), for displaying information to a computer user. An input device, including alphanumeric and other keys, can be coupled to the bus for communication of information and command selections to the processor. Another type of user input device is a cursor control, such as a mouse, a trackball or cursor direction keys for communicating direction information and command selections to the processor and for controlling cursor movement on the display. This input device typically has two degrees of freedom in two axes, a first axis (i.e., x) and a second axis (i.e., y), that allows the device to specify positions in a plane. However, it should be understood that input devices allowing for 3-dimensional (x, y and z) cursor movement are also contemplated herein.

Consistent with certain implementations of the present teachings, results can be provided by a computer system in response to a processor executing one or more sequences of one or more instructions contained in a memory. Such instructions can be read into a memory from another computer-readable medium or computer-readable storage medium, such as a storage device. Execution of the sequences of instructions contained in the memory can cause the processor to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, etc.) or “computer-readable storage medium” as used herein refers to any media that participates in providing instructions to a processor for execution. Such a medium can take many forms, including but not limited to, non-volatile media, volatile media, and transmission media. Examples of non-volatile media can include, but are not limited to, dynamic memory. Examples of transmission media can include, but are not limited to, coaxial cables, copper wire, and fiber optics, including the wires that comprise a bus.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, another memory chip or cartridge, or any other tangible medium from which a computer can read.

In addition to computer-readable medium, instructions or data can be provided as signals on transmission media included in a communications apparatus or system to provide sequences of one or more instructions to processor 104 of computer system 100 for execution. For example, a communication apparatus can include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, etc.

It should be appreciated that the methodologies described herein, flow charts, diagrams and accompanying disclosure can be implemented using computer system 100 as a standalone device or on a distributed network or shared computer processing resources such as a cloud computing network.

The methodologies described herein can be implemented by various means depending upon the application. For example, these methodologies can be implemented in hardware, firmware, software, or any combination thereof. For a hardware implementation, the processing unit can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings can be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, whereby the processor would execute the analyses and determinations provided by these engines, subject to instructions provided by any one of, or a combination of, memory components and user input provided via an input device.

Although specific embodiments and applications of the disclosure have been described in this specification, these embodiments and applications are exemplary only, and many variations are possible. Having described the various embodiments in detail, it will be apparent that modifications, variations, and equivalent embodiments are possible without departing from the scope of the disclosure defined in the appended claims. Furthermore, it should be appreciated that all examples in the present disclosure are provided as non-limiting examples.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that can have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A method for valuing an asset, the method comprising:
receiving documented evidence regarding a physical or digital asset;
transmitting the documented asset evidence to an AN, wherein the AN comprises:
one or more users capable of reviewing the asset evidence and submitting an appraisal bid;
logic to facilitate aggregation of appraisal bids;
an immutable ledger on which appraisal bids are received and which secures system operations;
reputation scoring capabilities which aggregate information over time, comprising:
assigning a reputation score to each AN user, wherein the score can be up or down modified by:
a user's reputational information;
feedback from other users; and
appraisal bid success rate; and
receiving and aggregating appraisal bids from the AN, comprising:
capturing appraisal bids from one or more users via one or more interface;
aggregating the appraisal bids;
weighting scores according to the reputation score of each user submitting an appraisal bid; and
analyzing the aggregation of appraisal bids for asset valuation;
receiving physical or digital documentation regarding asset value and/or sale price;
rewarding one or more users on the AN by a reward engine, comprising:
an incentive structure for participation and/or accurate appraisal bids;
customization of a plurality of reward options; and
weighting user scores based on comparison analysis of bids with asset value and/or sale price,
wherein machine learning and/or artificial intelligence are used to provide a reward and/or reward estimate; and
retaining bidding status and data over time in a secure, immutable ledger for auditing purposes.

2. The method of claim 1, wherein the asset comprises one or more selected from currency, digital currency, non-fungible tokens (NFTs), legal instruments (e.g., title to any tangible or intangible asset such as real estate, motor vehicles such as cars or boats), stocks, bonds, intellectual property (e.g., patents, trade secrets), art, tickets, coupons, tokens (such as casino tokens), notes, banking accounts, digital currency wallets, contracts, promissory notes, private keys, public keys, or any item with documentable value, or a group or portfolio of such assets.

3. The method of claim 1, wherein the asset is self-validating (has an accepted value).

4. The method of claim 1, wherein the asset is not self-validating (e.g., wherein the asset comprises title) and wherein documented evidence of the asset comprises more than one form of documentation for verification of a user and/or the asset.

5. The method of claim 1, wherein the documented asset evidence comprises one or more selected from physical identification, biometric data, witness evidence, multimedia evidence, bank statements, legal documents, chain of title and/or provenance, reputation score, and/or any physical documentation relating to the user and/or the asset.

6. The method of claim 1, wherein assigning a reputation score to each AN user comprises internal and/or external inputs, public and/or private inputs, and/or input from gamification within the network.

7. The method of claim 1, wherein the user's reputational information comprises one or more of the user activity, profile completion, historical bid success rate, accuracy over time, and/or documented educational and/or professional experience.

8. The method of claim 1, wherein the reward options comprise one or more of currency (fiat, crypto, etc.), points, tokens, and/or increased reputation score.

9. The method of claim 1, further comprising an asset-management system that provides on-location cryptographically secure asset digitization, adapted for handling of one or more items of at least one asset type, the system comprising:
a user interface;
an intake portal adapted to: a) receive documented evidence of one or more assets, and b) capture or assign a unique identifier for the asset;
a processor adapted to receive, process, and transmit said asset unique identifier;
a cryptographically secure immutable digital asset ledger for storing documented evidence of the asset;
and a means of providing a cryptographically unique proof of record.

10. The method of claim 9, wherein the user interface is implemented by an interaction between a machine and a user.

11. The method of claim 9, wherein the user interface comprises an app for a mobile device, a camera, a screen, a computer program, or a physical key.

12. The method of claim 9, wherein the intake portal captures the unique identifier present on the asset if the asset is self-validating, or creates a new unique identifier if the asset is not self-validating.

13. The method of claim 9, wherein the processor cryptographically secures the documented evidence captured by the intake portal by generating the unique digital signature of the evidence using a hashing function.

14. The method of claim 9, wherein the asset unique identifier is saved locally and on the immutable digital asset ledger.

15. The method of claim 9, wherein the immutable digital asset ledger comprises a system inventory of multiple asset items present in the system.

16. The method of claim 9, further comprising a physical or digital wallet storing the cryptographically unique proof of record.

17. The method of claim 9, wherein the asset unique identifier is unique to each asset item within an asset type, such that each asset item of a given asset type is distinguishable from every other item of said asset type.

18. The method of claim 9, wherein the system provides on-location cryptographic validation of a digital asset, wherein the system recognizes an immutable ledger in which the digital asset is registered and uses the ledger of record to validate the authenticity of the digital asset.

19. The method of claim 9. wherein the system provides on-location cryptographically secure exchange of assets.

20. The method of claim 1, wherein machine learning and/or AI are used in one or more steps of the method.
